(19) United States
(12) Patent Application Publication
(10) Pub. No.: US 2012/0319639 A1
(43) Pub. Date: Dec. 20, 2012

(54) TORQUE GENERATOR USING FULL-PITCH WINDING RELUCTANCE MOTOR AND CONTROL UNIT THEREFOR

(75) Inventors: Tomokazu ISHIKAWA, Nagoya (JP); Masayuki Nashiki, Komaki-shi (JP)

(73) Assignee: DENSO CORPORATION, Kariya-city (JP)

(21) Appl. No.: 13/527,987

(22) Filed: Jun. 20, 2012

(30) Foreign Application Priority Data
Jun. 20, 2011 (JP) 2011-136290

(51) Int. Cl. H02P 6/10

(52) U.S. Cl. 318/689

(57) ABSTRACT

A torque generator includes a full-pitch winding reluctance motor provided with three-phase or more coils which are composed of full-pitch windings, and a control unit therefor. The control unit controls currents supplied to the respective phase coils such that the coil for a first phase designated among the phases is first started to be current-supplied and then the coil for a second phase designated among the phases is started to be current-supplied during the current supply to the coil for the first phase. The control unit decreases an amount of the current supplied to the first coil immediately before starting the current supply to the second coil and to reinstate the amount of the current supplied to the first coil in response to starting the current supply to the second coil.

### CROSS-REFERENCE TO RELATED APPLICATION

This application is based on and claims the benefit of priority from earlier Japanese Patent Application No. 2011-136290 filed Jun. 20, 2011, the description of which is incorporated herein by reference.

### BACKGROUND

1. Technical Field

The present invention relates to a torque generator that generates torque using a full-pitch winding reluctance motor and a control unit for the motor.

2. Related Art

Torque generators using a full-pitch winding reluctance motor are well known as disclosed in a patent document JP-B-3157162. Current supply of such a full-pitch winding reluctance motor is controlled by a control unit. In controlling current supply, the control unit starts current supply to a first coil for a first designated phase and, while current is supplied to the designated phase, starts current supply to a second coil for a second designated phase adjacent to the first designated phase. The control unit repeatedly performs current supply in this manner. Thus, stator teeth, at which magnetic poles are induced, are sequentially switched to thereby activate a rotor.

As a specific example, the full-pitch winding reluctance motor disclosed in the patent document JP-B-3157162 includes A-, B- and C-phase coils. As shown in FIG. 1A, in unidirectionally rotating the rotor, the control unit stops current supply to the C-phase coil while current supply to the A-phase coil is underway and starts current supply to the B-phase coil adjacent to the A-phase coil. Also, the control unit stops current supply to the A-phase coil while current supply to the B-phase coil is underway and starts current supply to the C-phase coil adjacent to the B-phase coil. Further, the control unit stops current supply to the B-phase coil while current supply to the C-phase coil is underway and starts current supply to the A-phase coil adjacent to the C-phase coil. The control unit repeatedly performs this series of control. Thus, the stator teeth, at which magnetic poles are caused, are sequentially switched to thereby activate the rotor.

In this way, in a full-pitch winding reluctance motor, coils of different phases are simultaneously supplied with current. Specifically, compared to generally used short-pitch winding reluctance motors, full-pitch winding reluctance motors are able to increase the proportion of the coils supplied with current, by a factor of two.

As a result, full-pitch winding reluctance motors are able to raise the utilization factor of coils and obtain large output torque compared to short-pitch winding reluctance motors.

In addition, full-pitch winding reluctance motors are able to reduce winding resistance of coils compared to short-pitch winding reluctance motors, thereby reducing copper loss.

On the other hand, during current supply to the first-phase coil, such a full-pitch winding reluctance motor is required to smoothly pass current to the second-phase coil in starting current supply thereto.

However, such a full-pitch winding reluctance motor is ensured to start current supply to the second-phase coil in a period when the first-phase coil generates magnetic force. Accordingly, due to the influence of the magnetic force generated by the first-phase coil (influence of mutual inductance), the flow of current through the second-phase coil is likely to be impaired.

In order to explain in other words, the coil to which current supply is started first and which is caused an overlap of a current supply period is referred to as a first coil. Also, the coil to which current supply is started while current supply to the first coil is underway, and which causes the overlap of current supply period is referred to as a second coil. In this case, due to the influence of the magnetic force generated by the first coil (influence of mutual inductance), the flow of current through the second coil is likely to be impaired.

Referring to FIG. 4A, a specific example is explained.

As shown in the upper and middle portions of FIG. 4A, current supply to a B-phase coil is started while current supply to an A-phase coil is underway. In this case, in spite of the supply of current to the B-phase coil (applied current) at a level as indicated by a solid line Ib, the flow of current through the B-phase coil is impaired due to the influence of the magnetic force generated by the A-phase coil. Accordingly, the current actually supplied to the B-phase coil (passing current actually flows through the coil) is suppressed to a level as indicated by a broken line Ib′.

The same phenomenon occurs when current is supplied to the A- and C-phases and the B- and C-phases, as indicated by broken lines Ia′ and Ic′ in FIG. 4A.

In this way, when current supply to the second coil is started during the period when current is supplied to the first coil, the level of the current passed to the second coil is lowered due to the influence of mutual inductance. As a result, the stator teeth, at which magnetic poles are caused, generate only small magnetic force and thus the output torque of the motor is reduced.

In particular, as indicated by a solid line a in FIG. 5, as the rotational speed is increased, such as when the rotor is rotated at middle to high speed or at high speed, the output torque of the motor is decreased due to the influence of mutual inductance.

### SUMMARY

It is thus desired to provide a torque generator that uses a full-pitch winding reluctance motor, in which large current is passed through both of the first coil and the second coil to obtain large output torque, under the condition where current supply to the second coil is started during the period when current is supplied to the first coil.

As an exemplary embodiment, there is provided a torque generator including a full-pitch winding reluctance motor provided with three-phase or more coils which are composed of full-pitch windings; and a control unit for controlling currents supplied to the respective phase coils such that the coil for a first phase designated among the phases is first started to be current-supplied and then the coil for a second phase designated among the phases is started to be current-supplied during the current supply to the coil for the first phase. The control unit is configured to decrease an amount of the current supplied to the first coil immediately before starting the current supply to the second coil and to increase (i.e., reinstate) the amount of the current supplied to the first coil in response to starting the current supply to the second coil.

Thus, supply current for the first coil is temporarily decreased immediately before the start of current supply to the second coil. Accordingly, at the time when current supply to the second coil is started, the influence of magnetic force generated by the first coil (influence of mutual inductance) is mitigated.

As a result, current is easily passed through both of the first coil and the second coil when current supply to the second coil is started. Accordingly, from immediately after the start of current supply to the second coil, large current is passed through both of the first coil and the second coil.

In this way, the influence of mutual inductance is mitigated when current supply to the second coil is started. Accordingly, large current is passed through both of the first coil and the second coil immediately after the start of current supply to the second coil. As a result, large magnetic force is generated by the stator teeth at which magnetic poles are caused, and thus the motor is able to output large torque.

It is preferred that the control unit is configured to decrease, during the current supply to the first coil, the amount of the current to the first coil down to an amount which is ½ or less of an amount of the current supplied immediately before temporarily reducing the current, during the current supply to the first coil.

Thus, supply current for the first coil is decreased to ½ or less. Decrease of supply current in this way can mitigate the influence of magnetic force generated by the first coil (influence of mutual inductance). Accordingly, large current is passed through both of the first coil and the second coil immediately after the start of current supply to the second coil.

It is also preferred that the control unit is configured to temporarily decrease the amount of the current to the first coil down to zero, during the current supply to the first coil.

Thus, supply current for the first coil is decreased to zero. Decrease of supply current in this way can further mitigate the influence of magnetic force generated by the first coil (influence of mutual inductance). Accordingly, large current is passed through both of the first coil and the second coil immediately after the start of current supply to the second coil.

Preferably, the motor comprises a stator provided with stator teeth and a rotor provided with rotor teeth, and the control unit is configured to reinstate, after temporarily decreasing the current supply to the first coil, the amount of the current to the first coil at a first timing which is earlier than a second timing at which an overlap between the stator teeth and the rotor teeth starts in a rotary direction of the rotor.

In this case, the control unit may be configured to decrease, after temporarily decreasing the current supply to the first coil, the amount of the current to the first coil at a first timing which is earlier than a second timing when a center of each of the stator teeth and a center of each of the rotor teeth agree with each other in a rotary direction of the rotor.

### BRIEF DESCRIPTION OF THE DRAWINGS

In the accompanying drawings:

FIGS. 1A and 1B are time diagrams illustrating current supply patterns for A-, B- and C-phase coils, according to conventional art and according to a first embodiment of the present invention, respectively, for comparison;

FIG. 2 is a schematic diagram illustrating a configuration of a torque generator that generates torque using a full-pitch winding reluctance motor and a control unit, according to the first embodiment;

FIG. 3 is an explanatory diagram illustrating direction of winding of the A-, B- and C-phase coils in the full-pitch winding reluctance motor, according to the first embodiment;

FIGS. 4A and 4B are time diagrams illustrating current changes in current-supply patterns for the individual phases, according to conventional art and according to the first embodiment, respectively, for comparison;

FIG. 5 is an explanatory diagram illustrating a relationship between rotational speed and output torque of a motor, according to the first embodiment and conventional art, for comparison therebetween;

FIGS. 6A and 6B are time diagrams illustrating current supply patterns for A-, B- and C-phase coils, according to conventional art and according to a second embodiment of the present invention, respectively, for comparison;

FIGS. 7A and 7B are time diagrams illustrating current supply patterns for A-, B- and C-phase coils, according to conventional art and according to a third embodiment of the present invention, respectively, for comparison; and

FIGS. 8A and 8B are time diagrams illustrating current supply patterns for A-, B- and C-phase coils, according to conventional art and according to a fourth embodiment of the present invention, respectively, for comparison.

### DETAILED DESCRIPTION OF THE PREFERRED EMBODIMENTS

With reference to the accompanying drawings, hereinafter are described some embodiments of the present invention.

A torque generator includes a full-pitch winding reluctance motor 1 and a control unit 2. The full-pitch winding reluctance motor 1 has coils (exciting coils) of three or more phases, which are applied with full-pitch winding. The control unit 2 controls current supply to the coils of the individual phases. In the torque generator, while current is supplied to a first-phase coil or first coil, current supply to a second-phase coil or second coil is started. Thus, the current supply period of the first-phase coil overlaps with the current supply period of the second-phase coil. In other words, the current supply to the second coil is started in the middle of a current supply period of the first coil.

In controlling current supply, the control unit 2 temporarily decreases current supplied to the first coil, immediately before starting current supply to the second coil. Then, the control unit 2 starts current supply to the second coil and at the same time increases current supplied to the first coil.

Thus, the influence of mutual inductance is mitigated at the time when current supply to the second coil is started. Accordingly, large current is passed to both of the first coil and the second coil immediately after starting current supply to the second coil. As a result, the output torque of the full-pitch reluctance motor 1 is increased.

With reference to the accompanying drawings, hereinafter are described some specific examples (embodiments) of the torque generator of the present invention, which uses the full-pitch reluctance motor 1. The embodiments set forth below are only examples. Thus, as a matter of course, the present invention shall not be limited to the embodiments.

In the embodiments set forth below, identical and similar components are given the same reference numerals for the sake of omitting unnecessary explanation.

### First Embodiment

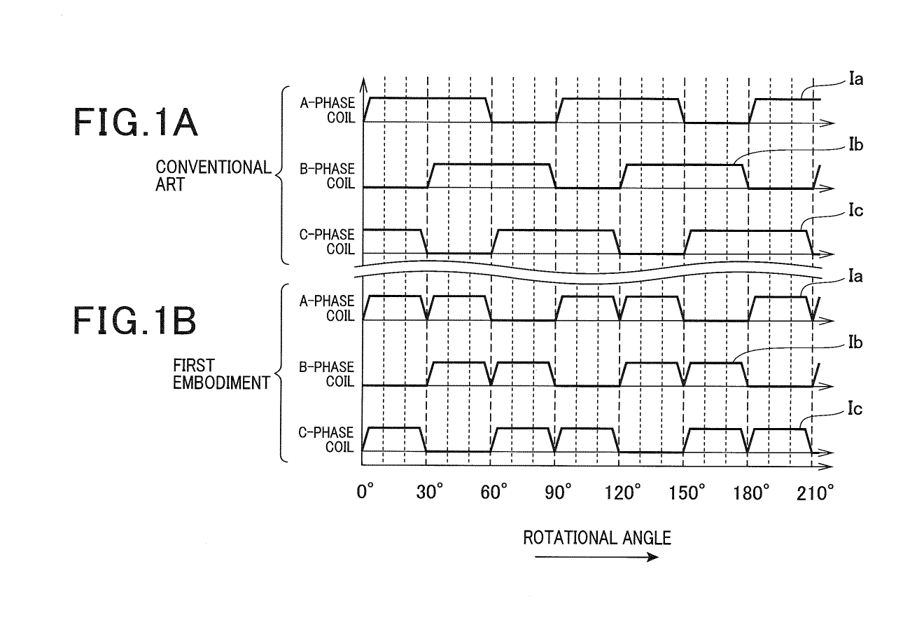

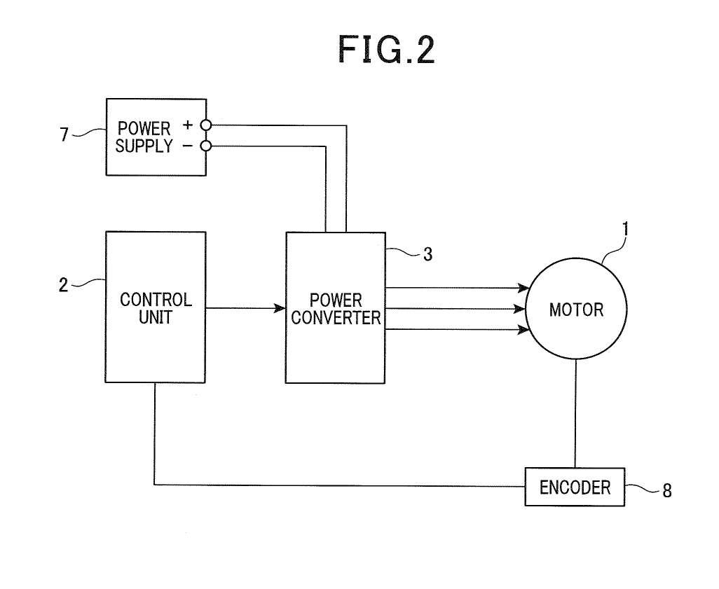

Referring to FIGS. 1A and 1B as well as FIGS. 2 to 5, a first embodiment of the present invention is described.

As a specific example, the torque generator of the present embodiment is installed in a vehicle, such as an electric vehicle or a hybrid vehicle, for the traveling (driving) of the vehicle, although no limitation shall be imposed by this application of the present invention to the torque generator.

As shown in FIG. 2, the torque generator includes the full-pitch winding reluctance motor 1, the control unit (electronic control unit (ECU)) 2 and a power converter (inverter) 3. The reluctance motor 1 has coils of three or more phases applied with full-pitch winding. The control unit 2 supplies current to the coils of the individual phases in the reluctance motor 1. The power converter 3 provides power to the coil of each of the phases, according to an instruction signal (e.g., duty ratio control signal) from the control unit 2.

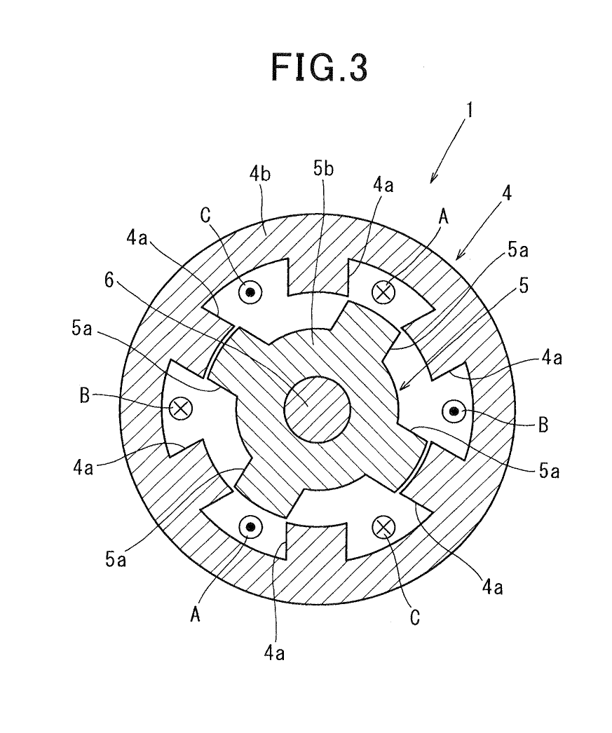

The full-pitch winding reluctance motor 1 is a switched reluctance motor (SR motor) having a well-known configuration and includes coils applied with full-pitch winding. Besides the coils of three or more phases, the reluctance motor 1 includes, as shown in FIG. 3, a stator core 4 and a rotor core 5.

An example of the full-pitch winding reluctance motor 1 is described below.

The stator core 4 includes stator teeth (stator salient poles) 4a and a back yoke 4b. The stator teeth 4a are provided by a number corresponding to 6×m (m is an integer of 1 or more) and arranged within an electrical angle of 360°, being equally spaced apart therebetween. The back yoke 4b electrically connects the stator teeth 4a with each other.

Referring to FIG. 3, the full-pitch winding reluctance motor 1 in which the rotor core 5 is arranged inside the stator core 4 is described as a specific example.

The stator core 4 of the present embodiment includes an annular back yoke 4b and six stator teeth 4a. The annular back yoke 4b is fixed to and arranged inside a motor housing (i.e. inside a cylindrically shaped yoke). The six stator teeth 4a are projected radially inward from the back yoke 4b.

Specifically, the stator core 4 is formed by stacking a plurality of electromagnetic steel plates (e.g., soft iron plates, silicon steel plates and amorphous metal plates), each having a surface on which an insulating film is formed.

The rotor core 5 includes rotor teeth (rotor salient poles) 5a and a ring core 5b. The rotor teeth 5a are provided by a number corresponding to 2×n (n is an integer of 1 or more) and arranged within an electrical angle of 360°, being equally spaced apart therebetween. The ring core 5b is connected to a rotor shaft (output shaft) 6.

In the specific example, the rotor core 5 is arranged inside the stator core 4 as mentioned above. Further, in the specific example, the rotor core 5 includes the ring core 5b and four rotor teeth 5a . The ring core 5b is fixed to the outer periphery of the rotor shaft 6 which is rotatably supported by the motor housing via a bearing. The four rotor teeth 5a are projected radially outward from the ring core 5b.

More specifically, similar to the stator core 4 described above, the rotor core 5 is formed by stacking a plurality of electromagnetic steel plates (e.g., soft iron plates, silicon steel plates or amorphous metal plates), each having a surface on which an insulating film is formed.

The stator core 4 is arranged coaxially with the rotor core 5. When the rotor core 5 is rotated, the stator teeth 4a are not in contact with the rotor teeth 5a. Further, in a state where a stator tooth 4a confronts a rotor tooth 5a, a predetermined clearance is provided therebetween.

Hereinafter is described a specific example of coils having three or more phases and applied with full-pitch winding.

In the present embodiment, the exciting coils have three phases, i.e. an A-phase coil A, a B-phase coil B and a C-phase coil C. These coils are arranged in slots, which are formed in the circumferential direction between the stator teeth 4a, being applied with full-pitch and concentrated winding.

Specifically, each of the A-, B- and C-phase coils A, B and C is arranged, being applied with concentrated winding, in two opposed slots which are spaced apart therebetween by 180° in the rotational direction. In this case, the coil of each phase is wound in a positive direction in one slot and wound in a negative (reverse) direction in the other opposed slot spaced apart by 180°.

Further, the coils of the individual phases, one being adjacent to the other in the circumferential direction, are provided being alternately wound in reverse direction. The coils are arranged such that, when current is simultaneously passed through adjacently located coils of two phases, current flows in reverse direction in these two coils.

In FIG. 3, the winding direction of the coils marked with circled “*” is different from that of the coils marked with circled “x”.

Hereinafter is described an example of operation of the full-pitch winding reluctance motor 1.

The following description is provided on the basis of an arrangement, as shown in FIG. 3, in which the B-phase coil B is arranged in a slot adjacent to the A-phase coil A in the clockwise direction, and the C-phase coil C is arranged in a slot adjacent to the B-phase coil B in the clockwise direction.

In a rotational angle range of 0° to 30°, current supply to the B-phase coil B is stopped while current is supplied to the A-phase coil A and the C-phase coil C (this is hereinafter referred to as a first pattern).

Thus, magnetic poles are induced in the two stator teeth 4a between the A-phase coil A and the C-phase coil C to magnetically attract thereto the rotor teeth 5a.

In the subsequent rotational angle range or 30° to 60°, current supply to the C-phase coil C is stopped while current is supplied to the A-phase coil A and the B-phase coil B (this is hereinafter referred to as a second pattern).

Thus, magnetic poles are caused in the two stator teeth 4a between the A-phase coil A and the B-phase coil B to magnetically attract thereto the rotor teeth 5a. As a result, torque is caused in the rotor in the counterclockwise direction.

In the subsequent rotational angle range or 60° to 90°, current supply to the A-phase coil A is stopped while current is supplied to the B-phase coil B and the C-phase coil C (this is hereinafter referred to as a third pattern).

Thus, magnetic poles are caused in the two stator teeth 4a between the B-phase coil B and the C-phase coil C to magnetically attract thereto the rotor teeth 5a. As a result, torque is caused in the rotor in the counterclockwise direction.

After that, every time the rotor is rotated by an angle 30°, the first, second and third current supply patterns are sequentially repeated. Every time the rotor is rotated by an angle of 30°, counterclockwise torque is caused in the rotor.

Specifically, counterclockwise rotation is caused in the rotor shaft 6:

by supplying current according to the first pattern in the subsequent rotational angle range of 90° to 120°;

by supplying current according to the second pattern in the subsequent rotational angle range of 120° to 150°;

by supplying current according to the third pattern in the subsequent rotational angle range of 150° to 180°;

by supplying current according to the first pattern in the subsequent rotational angle range of 180° to 210°;

by supplying current according to the second pattern in the subsequent rotational angle range of 210° to 240°;

by supplying current according to the third pattern in the subsequent rotational angle range of 240° to 270°;

by supplying current according to the first pattern in the subsequent rotational angle range of 270° to 300°;

by supplying current according to the second pattern in the subsequent rotational angle range of 300° to 330°; and

by supplying current according to the third pattern in the subsequent rotational angle range of 330° to 360°.

It should be appreciated that, when the first to third patterns are repeated in a reverse order, the full-pitch winding reluctance motor 1 is reversely rotated.

Hereinafter are described the control unit 2, which controls current supply of the reluctance motor 1, and the power converter 3.

The power converter 3 serves as an inverter circuit that applies power of an on-vehicle power supply 7 to the individual coils, according to an instruction signal from the control unit 2. The power converter 3 is composed of a plurality of power transistors (e.g., power FETs (field-effect transistors)).

The control unit 2 calculates a target output torque and a target rotational speed according to operating states (e.g., traveling states, such as a vehicle speed, and driver's manipulation states, such as an accelerator position) of the vehicle. Then, the control unit 2 allows the reluctance motor 1 to generate the calculated target output torque and the calculated target rotational speed.

Specifically, the reluctance motor 1 is provided with an encoder 8 inside or outside thereof to read a rotational angle. In activating the reluctance motor 1, the control unit 2 rotates the rotor according to a current supply pattern (any one of the first to third patterns described above) suitable for the rotational angle read by the encoder 8 to control rotation of the reluctance motor 1.

The control unit 2 controls current supplied to the coils of the individual phases such as by controlling duty ratio.

As described above, in activating the reluctance motor 1, the control unit 2 sequentially repeats the first to third patterns of current supply.

In this case:

Current supply periods for the A-phase coil A correspond to the rotational angle ranges of 0° to 60°, 90° to 150°, 180° to 240° and 270° to 330°;

Current supply periods for the B-phase coil B correspond to the rotational angle ranges of 30° to 90°, 120° to 180°, 210° to 270° and 300° to 360°; and

Current supply periods for the C-phase coil C correspond to the rotational angle ranges of 330° to 30°, 60° to 120°, 150° to 210° and 240° to 300°.

In this way:

Current supply to the B-phase coil B is started in the middle of each current supply period of the A-phase coil A;

Current supply to the C-phase coil C is started in the middle of each current supply period of the B-phase coil B; and

Current supply to the A-phase coil A is started in the middle of each current supply period of the C-phase coil C.

In other words, during each current supply period of the first-phase coil, current supply to the second-phase coil is started to cause an overlap in time between the first-phase coil and the second-phase coil.

As mentioned above, the first coil refers to the coil to which current supply is started first and which is caused an overlap of current supply period. Also, the second coil refers to the coil to which current supply is started while current supply to the first coil is underway, and which causes the overlap of current supply. In the present embodiment, the control unit 2 is ensured to temporarily decrease supply current for the first coil, immediately before starting current supply to the second coil. Then, with the start of current supply to the second coil, the control unit 2 is ensured to increase supply current for the first coil.

Specifically, as shown in FIG. 1B, the control unit 2 is ensured to:

temporarily decrease supply current for the C-phase coil C to which current supply is underway, immediately before the rotational angle ranges of 0°, 90°, 180° and 270° at which current supply to the A-phase coil A is started, and then start current supply to the A-phase coil A and at the same time increase supply current for the C-phase coil C;

temporarily decrease supply current for the A-phase coil A to which current supply is underway, immediately before the rotational angle ranges of 30°, 120°, 210° and 300° at which current supply to the B-phase coil B is started, and then start current supply to the B-phase coil B and at the same time increase supply current for the A-phase coil A; and

temporarily decrease supply current for the B-phase coil B to which current supply is underway, immediately before the rotational angle ranges of 60°, 150°, 240° and 330° at which current supply to the C-phase coil C is started, and then start current supply to the C-phase coil C and at the same time increase supply current for the B-phase coil B.

As described above, in the torque generator according to the present embodiment, the control unit 2 temporarily decreases supply current for the first coil in activating the full-pitch winding reluctance motor 1, immediately before starting current supply to the second coil and increases supply current for the first coil with the start of current supply to the second coil.

Thus, temporary decrease of supply current for the first coil immediately before starting current supply to the second coil can mitigate the influence of magnetic force (influence of mutual inductance) when current supply to the second coil is started, the magnetic force being generated by the first coil.

As a result, at the time when current supply to the second coil is started, current is easily passed through both of the first coil and the second coil. Thus, from immediately after the start of current supply to the second coil, large current is passed through both of the first coil and the second coil.

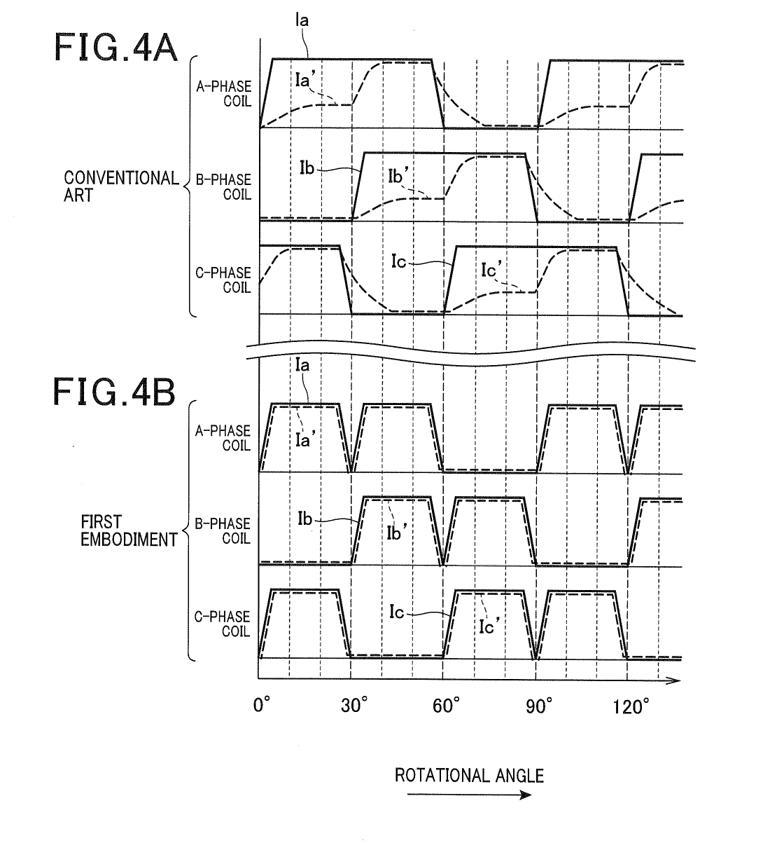

Referring to FIG. 4B, a specific example is explained. In FIGS. 4A and 4B, solid lines Ia, Ib and Ic indicate supply currents for the coils of the individual phases (applied currents). Also, broken lines Ia′, Ib′ and Ic′ indicate currents actually passing through the coils of the individual phases (passing currents).

As shown in the upper and middle portions of FIG. 4B, immediately before the start of current supply to the B-phase coil B (second coil of the moment), supply current for the A-phase coil A (first coil of the moment), to which current supply is underway, is temporarily decreased. Therefore, magnetic force generated by the A-phase coil A is temporarily decreased to temporarily mitigate the influence of mutual inductance.

As a result, current is easily passed through both of the A-phase coil A and the B-phase coil B when current supply to the B-phase coil B is started. Thus, the actual currents Ia′ and Ib′ passing through the A-phase coil A and the B-phase coil B are ensured to be substantially equal to the supply currents Ia and Ib for the A-phase coil A and the B-phase coil B.

As shown in the middle and lower portions of FIG. 4B, immediately before the start of current supply to the C-phase coil C (second coil of the moment), supply current for the B-phase coil B (first coil of the moment), to which current supply is underway, is temporarily decreased. Therefore, magnetic force generated by the B-phase coil B is temporarily decreased to temporarily mitigate the influence of mutual inductance.

As a result, current is easily passed through both of the B-phase coil B and the C-phase coil C when current supply to the

C-phase coil C is started. Thus, the actual currents Ib′ and Ic′ passing through the B-phase coil B and the C-phase coil C are ensured to be substantially equal to the supply currents Ib and Ic for the B-phase coil B and the C-phase coil C. As shown in the upper and lower portions of FIG. 4B, immediately before the start of current supply to the A-phase coil A (second coil of the moment), supply current for the C-phase coil C (first coil of the moment), to which current supply is underway, is temporarily decreased. Therefore, magnetic force generated by the C-phase coil C is temporarily decreased to temporarily mitigate the influence of mutual inductance.

As a result, current is easily passed through both of the A-phase coil A and the C-phase coil C when current supply to the A-phase coil A is started. Thus, the actual currents Ia′ and Ic′ passing through the A-phase coil A and the C-phase coil C are ensured to be substantially equal to the supply currents Ia and Ic for the A-phase coil A and the C-phase coil C.

In this way, the influence of mutual inductance is mitigated when current supply to the second coil is started. Accordingly, from immediately after the start of current supply to the second coil, a large current is passed through both of the first coil and the second coil to thereby increase magnetic force generated by the stator teeth 4a at which magnetic poles are caused. As a result, the full-pitch winding reluctance motor 1 is able to output a large torque.

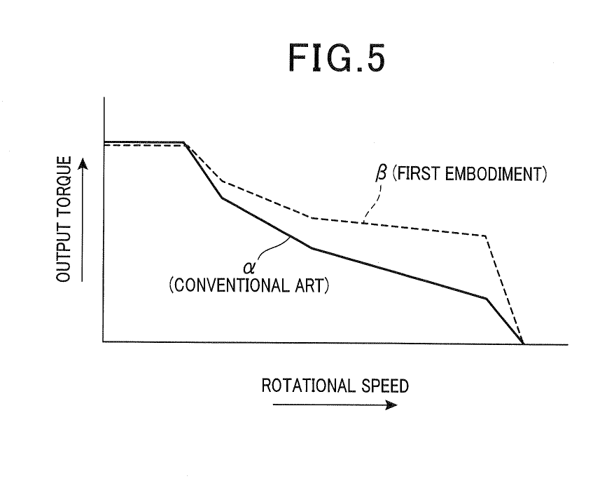

As mentioned above, the influence of mutual inductance is mitigated when current supply to the second coil is started. Owing to this, as indicated by a broken line β in FIG. 5, the output torque in a high-speed range is increased compared to conventional art (see the solid line a).

As shown in FIG. 1B, the control unit 2 according to the first embodiment temporarily decreases supply current for the first coil to zero in the period when current is supplied to the first coil.

Thus, decreasing the supply current for the first coil to zero, the influence of magnetic force (influence of mutual inductance) generated by the first coil is further mitigated. As a result, a large current is passed through both of the first coil and the second coil immediately after the start of current supply to the second coil.

In other words, the influence of mutual inductance is reliably decreased when current supply is switched from one phase to another.

Thus, the full-pitch winding reluctance motor 1 is able to output large torque.

As described above, supply current for the first coil is temporarily decreased while current supply thereto is underway, and then increased. The timing of the current increase is set to occur earlier than the timing when each stator tooth 4a and each rotor tooth 5a starts confronting, or overlapping, with each other in the rotational direction.

The control, under which the current increasing timing is ensured to occur earlier than the confrontation starting timing, may be performed throughout the entire speed range of the full-pitch winding reluctance motor 1, or may be performed according to the rotational speed or the requested output torque.

The timing when supply current for the first coil is temporarily decreased while current supply thereto is underway, i.e. current decreasing timing, is set to occur earlier than the timing when the center of a stator tooth 4a in the rotational direction coincides with the center of a rotor tooth 5a in the rotational direction, i.e. complete confrontation timing.

The current decreasing timing may be fixed or may be made variable depending on the rotational speed or the requested output torque.

### Second Embodiment

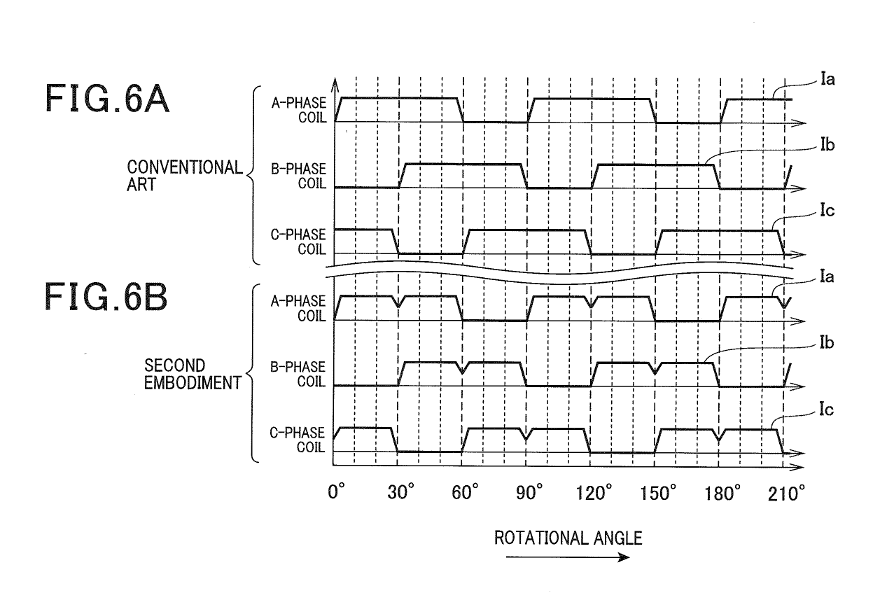

Referring to FIGS. 6A and 6B, a second embodiment of the present invention is described. In the second and the subsequent embodiments, the components identical with or similar to those of the first embodiment exert functions similar to those of the first embodiment.

The control unit 2 of the first embodiment described above decreases supply current for the first coil to zero, in temporarily decreasing supply current for the first coil while current supply thereto is underway. In this regard, as shown in FIG. 6B, the control unit 2 of the second embodiment temporarily decreases supply current for the first coil to ½ or less of the current immediately before the start of the temporal decrease, in temporarily decreasing supply current for the first coil while current supply thereto is underway. Thus, the decrease of supply current for the first coil to ½ or less can mitigate the influence of magnetic force generated by the first coil (influence of mutual inductance). Thus, immediately after the start of current supply to the second coil, large current is passed through both of the first coil and the second coil.

As a result, the full-pitch winding reluctance motor 1 is able to increase output torque in a middle to high speed range in particular, compared to conventional art.

A fixed amount of decrease (e.g., ½) may be used in the temporal decrease of the supply current for the first coil while current supply thereto is underway. Alternatively, the amount of decrease may be made variable depending on the rotational speed or the requested output torque.

### Third Embodiment

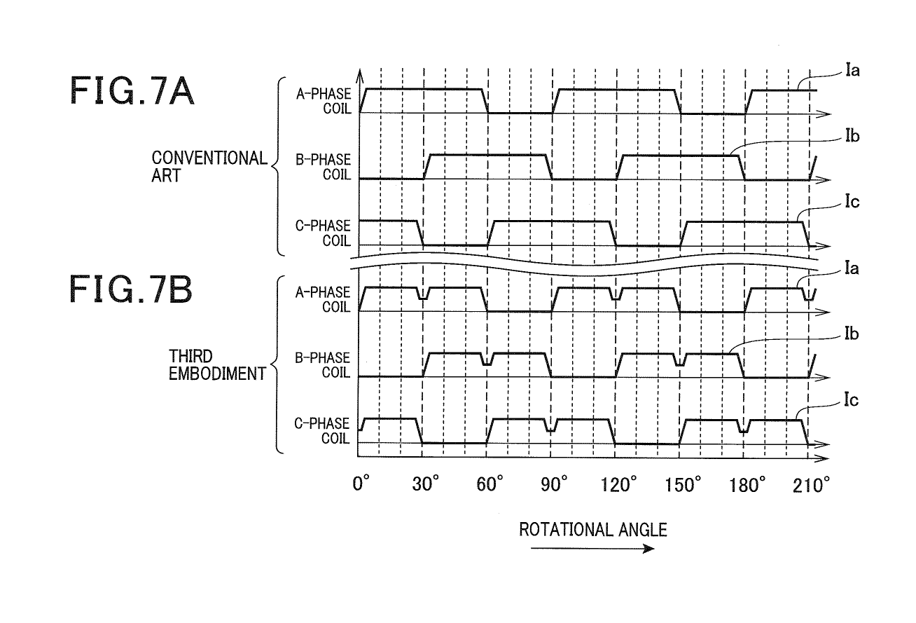

Referring to FIGS. 7A and 7B, a third embodiment of the present invention is described.

As shown in FIG. 7B, the control unit according to the third embodiment decreases supply current for the first coil to ½ or less and keeps the decreased state for a predetermined period, in temporarily decreasing supply current for the first coil while current supply thereto is underway.

Thus, with the duration of the decreased state of supply current for a predetermined period, the influence of mutual inductance is reliably mitigated.

As a result, the full-pitch winding reluctance motor 1 is able to increase output torque in a middle to high speed range in particular, compared to conventional art.

The predetermined period in which the current is kept at a low level may be fixed, or may be made variable depending on the rotational speed or the requested output torque.

### Fourth Embodiment

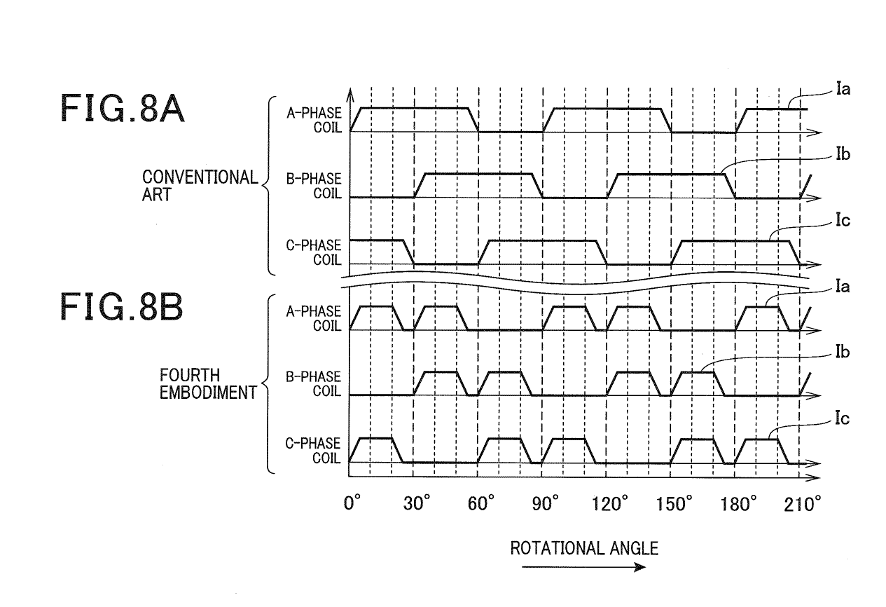

Referring to FIGS. 8A and 8B, a fourth embodiment of the present invention is described.

As shown in FIG. 8B, the control unit 2 according to the fourth embodiment decreases supply current for the first coil to zero and keeps the decreased state for a predetermined period, in temporarily decreasing supply current for the first coil while current supply thereto is underway.

Thus, supply current is cut off and the cut-off state is kept for a predetermined period to there by reliably further mitigate the influence of mutual inductance.

As a result, the full-pitch winding reluctance motor 1 is able to increase torque in a middle to high speed range in particular, compared to conventional art.

The predetermined period in which current is kept being cut off may be fixed or may be made variable depending on the rotational speed or the requested output torque.

The embodiments described above each exemplifies that the control according to the present invention is performed throughout the entire speed range. However, control according to the present invention may be ensured to be performed in a predetermined speed range or more, such as in a middle to high speed range or in a high speed range.

In the embodiments described above, the present invention is applied to a torque generator for driving a vehicle. However, the present invention may be applied to a different torque generator which is also installed in a vehicle to generate torque, without being limited to the driving of the vehicle. The different torque generator may, for example, be used for driving a refrigerant compressor for an air conditioner which is installed in vehicles such as electric vehicles. As a matter of course, the application of the present invention is not limited to vehicles. The present invention may be applied to various torque generators installed such as in industrial machines or household appliances.

The embodiment described above each exemplifies the full-pitch winding reluctance motor 1 of a type in which the rotor core 5 is arranged inside the stator core 4. However, the arrangement of and the relationship between the stator core 4 and the rotor core 5 are not limited to the ones exemplified in the above embodiments. For example, the reluctance motor 1 may be of a type in which the rotor core 5 is arranged outside the stator core 4. Alternatively, the reluctance motor 1 may be of a type in which the rotor core 5 is arranged in the axial direction of the stator core 4.

Alternatively, the reluctance motor 1 may be of a type in which the stator core 4 is arranged between an inner rotor core 5 and an outer rotor core 5. Alternatively, the reluctance motor 1 may be of a type in which the rotor core 5 is arranged between an inner stator core 4 and an outer stator core 4. In this way, the present invention may be applied to various types of the reluctance motor 1.

As a matter of course, the number of the stator teeth 4a or the number of the rotor teeth 5a disclosed in the above embodiments is only a specific example, but may be changed as appropriate according to the applications.

The present invention may be embodied in several other forms without departing from the spirit thereof. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A torque generator comprising:
a full-pitch winding reluctance motor provided with three-phase or more coils which are composed of full-pitch windings; and
a control unit for controlling currents supplied to the respective phase coils such that the coil for a first phase designated among the phases is first started to be supplied with current and then the coil for a second phase designated among the phases is started to be current-supplied during the current supply to the coil for the first phase, wherein the control unit is configured to decrease an amount of the current supplied to the first coil immediately before starting the current supply to the second coil and to reinstate the amount of the current supplied to the first coil in response to starting the current supply to the second coil.

2. The torque generator of claim 1, wherein the control unit is configured to decrease, during the current supply to the first coil, the amount of the current to the first coil down to an amount which is ½ or less of an amount of the current supplied immediately before temporarily reducing the current, during the current supply to the first coil.

3. The torque generator of claim 1, wherein the control unit is configured to temporarily decrease the amount of the current to the first coil down to zero, during the current supply to the first coil.

4. The torque generator of claim 1, wherein the motor comprises a stator provided with stator teeth and a rotor provided with rotor teeth, and the control unit is configured to reinstate, after temporarily decreasing the current supply to the first coil, the amount of the current to the first coil at a first timing which is earlier than a second timing at which an overlap between the stator teeth and the rotor teeth starts in a rotary direction of the rotor.

5. The torque generator of claim 2, wherein the motor comprises a stator provided with stator teeth and a rotor provided with rotor teeth, and the control unit is configured to reinstate, after temporarily decreasing the current supply to the first coil, the amount of the current to the first coil at a first timing which is earlier than a second timing at which an overlap between the stator teeth and the rotor teeth starts in a rotary direction of the rotor.

6. The torque generator of claim 3, wherein the motor comprises a stator provided with stator teeth and a rotor provided with rotor teeth, and the control unit is configured to reinstate, after temporarily decreasing the current supply to the first coil, the amount of the current to the first coil at a first timing which is earlier than a second timing at which an overlap between the stator teeth and the rotor teeth starts in a rotary direction of the rotor.

7. The torque generator of claim 1, wherein the motor comprises a stator provided with stator teeth and a rotor provided with rotor teeth, and the control unit is configured to decrease, after temporarily decreasing the current supply to the first coil, the amount of the current to the first coil at a first timing which is earlier than a second timing when a center of each of the stator teeth and a center of each of the rotor teeth agree with each other in a rotary direction of the rotor.

8. The torque generator of claim 2, wherein the motor comprises a stator provided with stator teeth and a rotor provided with rotor teeth, and the control unit is configured to decrease, after temporarily decreasing the current supply to the first coil, the amount of the current to the first coil at a first timing which is earlier than a second timing when a center of each of the stator teeth and a center of each of the rotor teeth agree with each other in a rotary direction of the rotor.

9. The torque generator of claim 3, wherein the motor comprises a stator provided with stator teeth and a rotor provided with rotor teeth, and the control unit is configured to decrease, after temporarily decreasing the current supply to the first coil, the amount of the current to the first coil at a first timing which is earlier than a second timing when a center of each of the stator teeth and a center of each of the rotor teeth agree with each other in a rotary direction of the rotor.

10. The torque generator of claim 4, wherein the motor comprises a stator provided with stator teeth and a rotor provided with rotor teeth, and the control unit is configured to decrease, after temporarily decreasing the current supply to the first coil, the amount of the current to the first coil at a first timing which is earlier than a second timing when a center of each of the stator teeth and a center of each of the rotor teeth agree with each other in a rotary direction of the rotor.

11. A method for controlling a torque generator comprising:
a full-pitch winding reluctance motor provided with three-phase or more coils which are composed of full-pitch windings; and
a control unit for controlling currents supplied to the respective phase coils such that the coil for a first phase designated among the phases is started to be supplied with current first, and then the coil for a second phase designated among the phases is started to be supplied with current during the current supply to the coil for the first phase, the method implemented in the control unit and comprising steps decreasing an amount of the current supplied to the first coil immediately before starting the current supply to the second coil; and
reinstating the amount of the current supplied to the first coil in response to starting the current supply to the second coil.
